(19) United States
(12) Patent Application Publication
(10) Pub. No.: US 2014/0278996 A1
(43) Pub. Date: Sep. 18, 2014

(54) Communication System

(71) Applicant: Bluepod Media Worldwide Limited, London (GB)

(72) Inventor: Paul Curry, Wallington (GB)

(73) Assignee: Bluepod Media Worldwide Limited, London (GB)

(21) Appl. No.: 14/292,988

(22) Filed: Jun. 2, 2014

Related U.S. Application Data
(63) Continuation of application No. PCT/GB12/00881, filed on Dec. 3, 2012.
(60) Provisional application No. 61/566,974, filed on Dec. 5, 2011.

(30) Foreign Application Priority Data
Dec. 2, 2011 (GB) 1120783.4
Jul. 31, 2012 (GB) 1213641.2

(51) Int. Cl. G06Q 30/02

(52) U.S. Cl. CPC G06Q 30/0257
USPC 705/14.55

(57) ABSTRACT

The present invention relates to communications systems generally and to closed systems such as WiFi systems in particular, especially where connections to the internet, an intranet or similar is possible and overlay messaging is required. The Internet has provided new avenues for providing commercial content to computer users such as providing product updates and delivering advertisements in general to consumers. The present invention, therefore, seeks to enable a service provider to deliver targeted brand content adapted to the determined communications environment to the client device. Accordingly, the present invention can provide content with regard to the location and/or system environment i.e. the determined communications environment of the client device and not upon a determination of the type of “surfer” or user of the device, their preferences, interests, keyword extraction and/or data traffic.

### FIELD OF THE INVENTION

The present invention relates to communications systems generally and to closed systems such as WiFi systems in particular, especially where connections to the internet, an intranet or similar is possible and overlay messaging is required.

### BACKGROUND

In broadcast television, advertisers utilize context-targeted advertising in which the commercials shown during breaks in the television programming are related to the content of the television programming or the target demographic of the television programming. The Internet has provided new avenues for providing commercial content to computer users such as providing product updates and delivering advertisements in general to consumers. An early form of Internet advertising is the banner advertisement (“banner ad”) which entails embedding an advertisement into a web page. The banner ad is intended to attract traffic to content, typically a website, of the advertiser. The advertisement can be constructed from a high-aspect ratio image, for example. Further, animation may be provided as indeed may sounds, whereby to maximize attention that is drawn to the advert. These advertisements can be positioned somewhere near the primary content for that web page (e.g., from a newspaper article or a collection of web portal links). The typical banner ad is purchased in bulk by the advertiser from a publisher of the web page. Often, the content of the advertising bears no relationship to the interests of the viewer, and therefore makes it unlikely that the viewer will attempt to click through to the website of the advertiser. In many cases, publishers over the Internet do not interact directly with advertisers, but instead rely on intermediaries to secure the advertisers.

Some website operators will tailor the advertisements served to users based on respective activity of the users. For example, when a user enters a search query on a search engine website, the website may deliver advertisements based on the search terms in addition to delivering the requested content. In such a case, the content provider (i.e., the search engine website) is the intended recipient of the search query from the user, so the content provider is able to provide targeted advertising based on the search query or the results from the relevant search websites. Thus, the content provider possesses the information necessary to make determinations regarding the content and context from the user. Other systems are available which base advertisements based upon the geographical address of a subscriber. This means that if you use a geographically-based internet service provider to access the world wide web or, for example, by virtue of a wireless network provide access to the world wide web, then focussed advertisements relating to such a physical location or network will be provided. Participants in such geographically-based advertising programmes will, accordingly, see advertisements on the websites they visit as more focussed towards potential needs/be perceived as being more relevant to them because of the demography of audience in the given location and knowledge of the time and context in which the advertiser content is being deployed.

There are three primary types of online messages such as notifications, advertisements: impression based, pay per click, and pay per action. Impression-based advertisements are presented to a user and are intended to raise the awareness of the product or service being advertised among all users. In this trading model, no user action is required in order to determine the compensation to the entity distributing the advertisement; the advertiser pays for each presentation or impression of the advertisement. Pay-per-click advertisements encourage users to click and activate a Uniform Resource Locator (URL) link to navigate to another website related to the advertisement. The entity distributing the pay-per-click advertisement is paid for each instance of a user activating the URL link. Similarly, pay-per-action advertisements require not only a user click but further user actions, such as the completion of an on-line form, before the advertiser pays for that advertisement. In all three cases, the effectiveness and cost of an advertisement depends on its relevancy to a user's interest and the ability for the entity to target users with specific interests.

The entities that provide WiFi and other computer systems and their agents have access to the information flow on such systems are hereafter referred to as “Service Providers”. In various ways, these service providers facilitate movement of packetized information in a computer system. Such service providers typically provide value-added services, such as providing “last-mile” hook-up of the system to the home, office, or mobile product, using systems the service providers own or systems owned by other service providers.

Service providers will typically examine information relating to the content being communicated over the service providers' networks. For example, service providers typically examine data packets to inspect for computer viruses, thereby enhancing the security of the network. In some cases, a service provider may even be able to obtain the first-hand knowledge how a subscriber browses the internet for relevant information. Nonetheless, the service provider is not properly equipped to provide commercial information that may be of high interest to its subscribers.

In public spaces such as shopping malls, cafes, department stores and the like, there is an increasing popularity of the wireless and non-wireless systems; a device may plug into an information point, such as a usb information point or may receive low power radio signals; equally a laptop may be hard-wired for secure message transmission.

The provision of information, whether it be a simple banner ad, an infomercial or even a safety message can include messages/signals/sounds/visuals/motions, and which shall hereinafter be referred to as “brand content”. It will be appreciated that there are problems realized by the provision of brand content: this can lead to a loss of utility on a client device. For example, an advert block will result in loss of potential revenue and a waste of advertising finances.

### Object to the Invention

The present invention seeks to overcome or ameliorate at least some of the disadvantages described above. The present invention, therefore, seeks to enable a service provider to deliver targeted brand content based on information communicated over the system of the service provider. The present invention, therefore, also seeks to enable a service provider to deliver targeted information based.

### Statement of Invention

In accordance with a general aspect, the present invention provides a system, a system of operation and device entities therefor which provide, operate and assist in a fashion so as to determine characteristics of environment diversity in a telecommunications system and adapt a response whereby data and/or information addressed to a user of the system is communicated to the user.

In accordance with a first aspect of the present invention, a method of providing brand content in a communications system is disclosed, the communications system comprising: an access point, an in-line server and a web-server, the access point providing a link to a client device with respect to the web-server, the web-server providing access to the worldwide web, wherein a client device can be provided with brand content from a brand content server, wherein; upon receiving a web request from a client device, the in-line server determines the communications environment and forwards the web request to a web-server; upon receipt of web content from said web server the in-line server analyzes the web content and inserts executable script in the parsed content in a position detected within the parsed content as appropriate to the determined communications environment, said executable script causing the client device to request brand content from the brand content server, the brand content server returning brand content adapted to the determined communications environment to the client device. Accordingly, the present invention can provide content with regard to the location and/or system environment i.e. the determined communications environment of the client device and not upon a determination of the type of “surfer” or user of the device, their preferences, interests, keyword extraction and/or data traffic.

The access point can provide at least one of a wireless link, cable link or optical link with a client device. The access point can provide a wireless link to a client device, for example in a WiFi environment, within a shopping mall. The access point could also comprise a cable or optical link with a client device, for example in a secure cable environment. The access point may be associated with the in-line server. Indeed, the brand content server could be associated with the access point or in-line server, although can be linked by virtue of a web connection.

The in-line server is conveniently a transparent server, whereby the function of the in-line server is performed in a transparent fashion to the system. The brand content server can be associated with the access point. The brand content server could be associated with other components of the system, such as the in-line server or the web-server. Equally, the in-line server could be physically associated with the access point. The in-line server conveniently acts as a proxy server.

Accordingly, the in-line server, upon the reception of a web request from the client device, monitors the environment of the communications system and specific web request, conveniently in a transparent fashion to the system; forwarding the web request to the web server and subsequently receiving web content; analyzing the received web content, inserting executable script in the parsed content in a position detected within the parsed content as appropriate to the environment and providing modified content in the appropriate web-language to said client device; sending an application request to the brand content server from the client device and receiving an application request at the brand content server; returning an application payload from the brand content server in response to said application request; sending a brand content request to the brand content server from the client device; and, returning brand content from the brand content server in response to said brand content request. In this fashion, an area of display, for example is populated using this brand content. This brand content display could be a banner advert. The brand content is displayed in a fashion with regard to the environment as determined by the transparent server. Following the return of an application payload from the brand content server in response to said application request a communication socket could be established between the brand content server and the client device, whereby commands could be passed, debug information and other useful information.

Broadly speaking, the present invention pertains to a system or system device configured to provide targeted brand content to a client device based on some or all of data traffic generated by the user. According to one aspect of the present invention, different from a proxy server, the system device operates transparently from both perspectives of the computer being used by the user and a website being visited by the user. According to one embodiment, the system device is disposed in line between the computer and the system so that all data traffic is examined. The data packets exchanged between a computer and a website being visited are altered or modified in such a way that the head of the packets remains largely intact while the payloads of the packets are changed to provide targeted data, instructions or information, as appropriate with regard to the environment of the user.

The web-language can be hyper-text mark-up language. The use of this language is widespread, but other languages can be deployed. The executable script in the web-language is conveniently JavaScript. Some of the factors taken into account in the monitoring include at least one of the following elements: the type of client device; the communications protocol between the communications access point and the client device; the web language; the executable script language. Some of the factors taken into account in the type of client device include at least one of the following factors: Type of display; display size; display orientation; mode of operation; touch sensitive features; audio features etc. A look-up table may be employed.

According to another aspect of the present invention, the system device is configured to analyze the browsing environment of a user in a communications context or behavioural activities of a user. Upon review and analysis and/or manipulation of the browsing environment and/or browsing activities of the user, commercial information most likely to interest the user is assembled and delivered to the user in an effective fashion.

The present invention may be implemented as a method, a process, a device or a part of a system. According to one embodiment, the present invention is a system device for monitoring the data transfer environment between a client device and a server device, the system device comprising: a transfer monitor to transparently intercept data packets being exchanged between the client device and the server device, the transfer monitor being configured to monitor at least one of: the device screen (resolution) and browser type (property) for Windows, Android and other operating systems; and, cause the brand content to be most appropriately played back/displayed or otherwise on or by the device.

For example, if the transfer monitor noted that a particular portion of a device screen was not displaying any meaningful content, then the transfer monitor could cause brand content to be displayed in such a particular portion of the screen.

The system could be configured to display, for emergency purposes, by way of example, the advisory content in a prominent fashion above all other screen data in appropriate/optimum place on the device screen.

In accordance with another aspect of the invention, there is provided a method of providing brand content in a communications system comprising a web-server, an access point and a transparent server, wherein a client device can be provided with brand content from a brand content server, wherein; the transparent server, upon the reception of a web request from the client device, monitors the environment of the communications system and specific web request, in a transparent fashion to the system; forwarding the web request to the web server and subsequently receiving web content; analyzing the received web content, inserting executable script in the web-language after a header appropriate to the environment and providing modified content in the appropriate web-language to said client device; sending an application request to the brand content server from the client device and receiving an application request at the brand content server; returning an application payload from the brand content server in response to said application request; sending a brand content request to the brand content server from the client device; and, returning brand content from the brand content server in response to said brand content request.

According to another embodiment, the present invention is a method for monitoring data traffic between a client device and a server device, the method comprising: intercepting a flow of data packets, each having a destination address; detecting whether the data packets satisfying predetermined selection criteria; modifying payloads of the data packets to include targeted commercial information; and forwarding the flow of the modified data packets to the destination address. Accordingly, the present invention can, therefore, enable a service provider to deliver targeted brand content based, at least, upon a partial determination of the communications environment.

According to still further embodiment, the present invention comprises a communications system comprising: an access point, an in-line server and a web-server; wherein: the access point is operable to provide a link to a client device with respect to the web-server; the web-server is operable to provide access to the worldwide web; and, a client device can be provided with brand content from a brand content server, wherein; upon receipt of a web request from a client device operating within the system, the in-line server can determine the communications environment and can forward the web request to a web-server; and, upon receipt of web content from said web server, the in-line server is operable to analyze the web content and can insert executable script in the parsed content in a position detected within the parsed content as appropriate to the determined communications environment, said executable script causing the client device to request brand content from the brand content server, the brand content server returning brand content adapted to the determined communications environment to the client device.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE DRAWINGS

Reference shall now be made to the drawings as shown in the accompanying drawing sheets, wherein:

FIG. 1 schematically represents a known wireless internet access system;

FIGS. 2a & 2b schematically represents first and second configurations of a wireless internet access system in accordance with the invention;

FIG. 3 schematically represents an implementation of a transparent proxy in accordance with an embodiment of the invention;

FIG. 4a is a flow chart providing a cross-section through a generic device in accordance with the invention;

FIG. 4b is a flow chart relating to the tasks involved in accordance with one aspect of the invention;

FIG. 4c shows an example of brand content being displayed;

FIGS. 5a & 5b show how script can be inserted into html script whereby to provide different functions; and

FIGS. 6a & 6b show how html script can react in two differing environments.

### DETAILED DESCRIPTION OF THE PREFERRED EMBODIMENTS

There will now be described, by way of example only, the best mode contemplated by the inventor for carrying out the present invention. This section is for the purpose of summarizing some aspects of the present invention and to briefly introduce some preferred embodiments. In the following description, numerous specific details are set out in order to provide a complete understanding to the present invention. Simplifications or omissions in this section as well as in the abstract and the title may be made to avoid obscuring the purpose of this section, the abstract and the title. It will be apparent to those skilled in the art that the present invention may be put into practice with variations of the specific—for example hypertext markup language (html) is referred to as JavaScript, but other languages can be used as alternatives—and any such simplifications or omissions are not intended to limit the scope of the present invention.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

Applicants have considered the many problems and issues relating to the representation of brand content on client devices and have realized that many issues relating to the non-transmission of signal/data is due to the inherent incompatibility between systems, protocols and devices arise through the plethora of environments of transmission, display and relative incompatibility of many of such environments. For the purposes of the present disclosure, environment diversity shall be considered as arising from a variety of systems and devices in use. Examples of environment diversity can be device specific: browser type, 2-D representation; 3-D representation; screen orientation; screen size; screen resolution or can be system/protocol specific. Environment diversity results in a loss of representation of output (visual/audio/tactile etc.)—some of which may not affect a users perception but most environment diversity aspects will result in a loss of performance.

In accordance with one aspect of the present invention, a system and method are provided for enabling a service provider to monitor a system and user devices (client devices) of a system in order to provide more relevant messages to the users based on the monitored environment. Service providers can extract contextual information from the content and provide context advertising in the same way as intermediary companies. In addition, due to the fact that service providers are exposed to all content a user consumes, service providers can derive user behavioural information from the collection of user content and use such unique information to serve even more relevant advertisement compared to intermediary companies.

Referring now to the drawings, in which like numerals refer to like parts throughout the several views. FIG. 1 is a simplified block diagram of an environment 100 in which a system device (1) of a client may communicate with a wireless access point (2). The wireless access point communicates with an IP system/internet/intranet via a server 5, conveniently provided with a content filter. A content server (11) is connected to the IP system (10) whereby to provide data to the internet and thus to the client device.

FIG. 2a shows a block diagram of a first implementation of a system in accordance with the invention. As is the situation with the prior art, a client using a mobile device communicates with the IP system (10) via a wireless access point (2) and server (5) with content filter. An inline server, conveniently a transparent server (3) is provided, and is placed between the wireless access point and the content filter server (5). The transparent server is linked to a brand content server (15)—which is also connected to the internet, whereby information such as brand content can be inserted from a content server (11), in a remote location. As will be appreciated, data from a local store (not shown) could be downloaded rather than from the internet, as shown. FIG. 2b shows a second implementation, where the transparent server (3) is placed between the content filter server (5) and the internet (10). As will be appreciated, the transparent server could be physically associated with the wireless access point or may be in a communications network utility module, for example in a telecommunications centre exchange. The in-line server can be linked to a statistics database.

FIG. 3 shows how the transparent proxy server (30) can operate in a simple block fashion. As the data is transferred, for example, an input page in hypertext markup language (html) is communicated via the server. As is known, html elements comprise the basic building elements of web pages and html enables images, objects, etc. to be embedded within websites, creating headings, separators, documents, links and other functional features. JavaScript is a language that can be used to control webpages and their content. A web browser functions to read html documents and cause certain actions to be performed e.g. the provision of a visible page or produce a sound. In this Figure, the proxy server implements an html inspection on data traffic and adds JavaScript as appropriate. For example, reference can be made to a fragile list database—e.g. blocking capabilities re parental control/authorization required or text known to be non-compliant with one of a number of factors relating to the operation of the system. Because the transparent proxy server is configured not to after the header portion of each data packet and only modify the payloads of some of the data packets, the presence of such a proxy server in the system is transparent to either sides (e.g. the client device and the publisher).

FIG. 4 comprises a proxy flow chart. In the first instance a new website request is made by a user of a device (client device) within a system of the system. A scan is made of the environment to determine what attributes the system has and how such attributes can be accounted for in the provision of information by a service provider. For example the system html header is examined to determine whether or not the website is local to the system. If this is the case, the server could allow the request and make no amendments or insertions to the data traffic. If the website is determined as being on a fragile list then, again, no further action may be made with respect to the data traffic. When a termination tag is determined, equally nothing will be performed upon the subsequent data flow; if a particular data tag such as <xxxx> or </xxxx>, then JavaScript appropriate to the environment is inserted in a suitable location within the html data, and the data traffic is allowed through.

To assist in the flow chart above reference shall be made to FIG. 4b which shows the flow of events with respect to components and devices within the system. A process in accordance with the invention can start as follows: initially, a user launches an application, such as a web browser or an instant messaging application, on the client device (1) and the web content request (402) is made via the transparent server (3), which then detects the environment (404) and checks the content of such a request (406) providing a blank screen/error message etc. as appropriate and subsequently forwards the request for web content (408) from the Webserver (11). This may be, for example, an HTTP request to retrieve a particular webpage from a website of the content provider. Assuming that the webserver can satisfy the request for data, html content is returned from the Webserver to the transparent server (3). At this stage, the web content is analyzed in a first step (412); a JavaScript tag is added after the <head> tag, appropriate to the environment, as determined in step (404) and the appropriately modified html content. Upon receipt of such modified html content, the end user device will then execute the JavaScript in the client device (1) browser. FIG. 4c shows an implementation of the invention wherein in a message (42)—in this case substantially a written message—a brand message “EMPIRE” (43)—is overlaid a portion of the message (42); details of browsing time could be included, for example.

In performing the JavaScript execution, which is a skeletal instruction, the end user device shall make an application Request (421) to the proxy server, which tells the browser to go ahead and fetch the actual JavaScript payload from the webserver, which links with the brand content server. Upon receipt of such a request, then a return application payload (422) is provided. That is to say, the JavaScript responsible for a modification to the page is returned to the client device (1) browser, and executed. It has been found that it can be useful for the JavaScript to establish a communication socket (425) back to the brand content server (15), which can be used to pass commands, debug information or other useful information. FIGS. 5a & 5b show how JavaScript can be inserted into html script whereby to provide different functions. Equally, FIGS. 6a & 6b shows how html script can react in two differing environments.

When the JavaScript is in a position to do so, the client device will request brand content information from the brand content server; upon completion of the request by the return of brand content, from the brand content server (15) which will satisfy the requirement of brand content, in the appropriate data space, whether it be a banner in an unfilled section of screen, an audio message, activation of a vibratory mode etc. fill the appropriate data. That is to say, the requirement for population of the brand content area is satisfied by the supply of this information.

In this environment, a first user at a first communication device, e.g., mobile/personal notepad/near field communicator/Bluetooth® device, may be coupled to the Internet (10) via a service provider.

The transparent server (3) may be deployed in an inline fashion and placed at a location in a system where there is a high probability that data packets carrying content both generated by and consumed by the end-user can be conveniently examined. For example, the transparent server (3) may be implemented in a router or a switch. In one embodiment, the transparent server (3) may be a standalone device that is to be disposed in a line to intercept data packets. Because such a system device in one embodiment, as will be further explained below, is configured not to after the header portion of each data packet and only modify the payloads of some of the data packets, their presence in the system is transparent to either sides (e.g., the user and the publisher).

The transparent server (3) comprises various functional units capable of the inspection, analysis, and modification of system flow. In accordance with various embodiments, the brand content server (15) can handle one or more types of Internet Protocol (IP) based application protocols, including but not limited to, for example, HTTP, WAP, and RTP. The inspection, analysis, and modification of system flow may be used for the purposes of facilitating information distribution to the end users. Because the brand content server (15) is implemented at a location through which multiple devices pass data, each brand content server (15) will service multiple end users.

The brand content server (15) may insert advertising so that it is displayed directly on the device (1). Alternatively, the brand content server 15 may insert links to advertising in the content displayed on the device (1) so that the advertising is displayed if the user chooses to follow the link. The brand content server (15) may eliminate or substitute existing links in a web page as the web page is being downloaded from the web content server (11) to the device (1).

Referring back to FIG. 2a, if we consider the wireless access point (2) to be a WiFi system in a shopping mall, then upon a client device (1) accessing the system, for example by the user taking his device from a pocket, for example, and turning the device on. The client device (1) will make a website request and will communicate with the WiFi system upon an appropriate transmission protocol as determined by a telecommunications handshake. At this stage the transparent proxy shall determine what type of device the client device is and from a look-up table determine how it will display data to the user, by virtue of an indication of the type of display, size, orientation, mode of operation (keyboard visible on a touch screen, for example) and the like. The transparent proxy will also implement html inspection and determine the nature of the html, with a view of enabling the inclusion of brand content. For example the brand content, instead of being presented as a banner visualization, may be presented over text as exemplified in FIG. 4c—whereby to draw attention to the advert. The brand content such as an advert can be moved about the screen, but will also thereby, most likely, be increasing the effectiveness of the brand content or advert. It will be appreciated that the term “brand content” is to be interpreted as meaning “content of any form” and is not restricted to advertisements per se. The smallness of mobile device screens will, typically, mean that there is no unused part of the screen to place the brand content—although it could also be placed in an unused part of the display or may replace another section of the display on a selective basis, with regard to the environment of the display taking into account the nature of the wireless/WiFi enabled device. Equally, the presence of any brand content blocking means may be disabled or respected, dependent upon settings of the system. The brand content may be dependent upon a browsing history. The brand content may be dependent upon the actual proximity of an outlet which is in the habit of paying for advertisements by the system. The JavaScript appropriate for the environment will then be inserted in a suitable location in the html script.

In contrast to prior-art systems, which systems are configured so that users content or traffic analysis (Interests of the user′) determine the nature of inserted content, the present invention is based on the provision of insertion based upon location and/or system. Specifically the present invention does not perform an analysis based upon traffic or content monitoring/analysis but, in a different approach, is based upon location and/or serving system. However, the system may be further configured to either target or to exclude certain groups of users for analysis and/or advertising content insertion. This can be based upon the type of user device or service level agreement, for example. In some cases, a particular user device or a collection of user devices may be identified as being exempt from content insertion (e.g., if a user or group pays an extra fee for advertising-free service; equally if only one type of user device can perform a particular application, then advertisements relating to such an application for users who cannot perform such an application are meaningless). A site-logging function can be provided and would be operable to log a history of activities performed by a user. For example, the site-logging function may determine a history of site-visits by the user. Such a site logging function may enable a reduction in memory size for ease of storage of the data. Different types of memory devices may be used, including, but not limited to, randomly addressable memory, static, dynamic, flash, hard drive, and EEPROM.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

1. A method of providing brand content in a communications system, the communications system comprising: an access point, an in-line server and a web-server, the access point providing a link to a client device with respect to the web-server, the web-server providing access to the worldwide web, wherein a client device can be provided with brand content from a brand content server, wherein;
upon receiving a web request from a client device, the in-line server determines the communications environment and forwards the web request to a web-server;
upon receipt of web content from said web-server the in-line server analyzes the web content and inserts executable script in a parsed section of the web content in a position detected within the parsed content as being appropriate to the determined communications environment, said executable script causing the client device to request brand content from the brand content server, the brand content server returning brand content adapted to the determined communications environment to the client device.

2. A method according to claim 1, wherein following an initial communication exchange between the client device and the brand content server; a communication socket is established between the brand content server and the client device, which can be used to pass commands, debug information or other useful information.

3. A method according to claim 1, wherein the in-line server is a transparent server, whereby the server operates transparently from both perspectives of the computer being used by the user and a website being visited by the user.

4. A method according to claim 1, wherein the web-language is hyper-text mark-up language.

5. A method according to claim 1, wherein the executable script in the web-language is JavaScript.

6. A method according to claim 1, wherein factors taken into account in the monitoring include at least one of the following elements:
the type of client device; the communications protocol between the communications access point and the client device; the web language; and the executable script language.

7. A method according to claim 6, wherein the factors taken into account in the type of client device include at least one of the following factors: Type of display; display size; display orientation; mode of operation; touch sensitive features; and audio features.

8. A method according to claim 6, wherein the factors are taken into account with reference to a look-up table.

9. A method according to claim 1, wherein the access point provides at least one of a wireless link, cable link or optical link with a client device.

10. A method according to claim 1, wherein the in-line server is a transparent server, whereby the function of the in-line server is performed in a transparent fashion to the system.

11. A method according to claim 1, wherein the in-line server is physically associated with the access point.

12. A method according to claim 1, wherein the brand content server is associated with the access point.

13. A method according to claim 1, wherein the brand content server is associated with the in-line server.

14. A method according to claim 1, wherein the brand content server is associated with the web-server.

15. A communications system comprising: an access point, an in-line server and a web-server; wherein:
the access point is operable to provide a link to a client device with respect to the web-server;
the web-server is operable to provide access to the worldwide web; and, a client device can be provided with brand content from a brand content server,
wherein; upon receipt of a web request from a client device operating within the communications system, the in-line server can determine a communications environment and can forward the web request to a web-server; and,
upon receipt of web content from said web-server, the in-line server is operable to analyze the web content and can insert executable script in the parsed content in a position detected within the parsed content as appropriate to the determined communications environment, said executable script causing the client device to request brand content from the brand content server, the brand content server returning brand content adapted to the determined communications environment to the client device.

16. A communications system according to claim 15, wherein the access point provides at least one of a wireless link, cable link or optical link with a client device.

17. A communications system according to claim 15, wherein the in-line server is a transparent server, whereby the function of the in-line server is performed in a transparent fashion to the system.

18. A communications system according to claim 15, wherein the in-line server is physically associated with the access point.

19. A communications system according to claim 15, wherein the brand content server is associated with the access point.

20. A communications system according to claim 15, wherein the brand content server is associated with the in-line server.

21. A communications system according to claim 15, wherein the brand content server is associated with the web-server.

22-23. (canceled)
